(19) United States
(12) Patent Application Publication
(10) Pub. No.: US 2025/0252273 A1
(43) Pub. Date: Aug. 7, 2025

(54) DIGITAL GRAPHICAL LANGUAGE SYSTEM FOR ORACLE BONE INSCRIPTIONS

(71) Applicant: Tianyiwen Li, Kunming (CN)

(72) Inventor: Tianyiwen Li, Kunming (CN)

(21) Appl. No.: 18/434,827

(22) Filed: Feb. 7, 2024

(51) Int. Cl. G06F 40/53; G06F 40/106; G06F 40/58

(52) U.S. Cl. CPC G06F 40/53; G06F 40/106; G06F 40/58

(57) ABSTRACT

A digital graphical language system for oracle bone inscriptions comprises a sentence collection module, an odd-even classification module, an odd number processing module, an even number processing module, a database module, and a graphical display module. The system first transmits the collected information to the odd-even classification module through the sentence collection module for classification; then, the information is separately sent to the odd number processing module or even number processing module for reorganizing of Pinyin letters; finally, the corresponding oracle bone inscription image is obtained and displayed through the graphical display module. The odd-even classification module is used to classify all Chinese vocabulary into odd and even categories; the odd number processing module is used to apply a specific Pinyin reorganizing method to odd class vocabulary to obtain the corresponding oracle bone inscription.

### 1. TECHNICAL FIELD

The invention relates to the technical field of graphical language systems, in particular to a digital graphical language system for oracle bone inscriptions.

### 2. BACKGROUND ART

In existing technology, the digital restoration of oracle bone inscriptions primarily relies on image processing methods, which involve identifying the characteristics of oracle bone inscription images for restoration. However, this approach encounters challenges when dealing with complex and large-scale oracle bone inscription data, such as large amount of calculation and unstable accuracy. Furthermore, existing methods lack in-depth exploration and utilization of the intrinsic structure and laws of oracle bone inscriptions, making it difficult to achieve efficient and accurate restoration. With the continuous development of digital technology, the digital processing and presentation of cultural heritage have become important research directions. Oracle bone inscriptions, as a precious historical and cultural heritage of China, hold significant importance in terms of its digital processing and presentation.

However, currently there are few digital graphical language systems for oracle bone inscriptions available on the market, or the existing related technologies have certain flaws, such as low efficiency and accuracy, which cannot meet the needs of modern research and protection.

### 3. SUMMARY OF THE INVENTION

The object of the invention is to overcome the above technical defects, and provide a digital graphical language system for oracle bone inscriptions to solve the problems of low efficiency and accuracy, and the problem that they cannot meet the needs of modern research and protection.

In order to realize the above technical problems, the invention provides the following technical scheme: a digital graphical language system for oracle bone inscriptions comprises a sentence collection module, an odd-even classification module, an odd number processing module, an even number processing module, a database module, and a graphical display module; the system first transmits the collected information to the odd-even classification module through the sentence collection module for classification; then, the information is separately sent to the odd number processing module or even number processing module for reorganizing of Pinyin letters; finally, the corresponding oracle bone inscription image is obtained and displayed through the graphical display module.

Further, the sentence collection module is used to collect Chinese articles and sentences, and transmit the collected information to the odd-even classification module; the odd-even classification module analyzes the articles and sentences collected by the sentence collection module, and translates the analyzed results into other languages for output; after the odd-even classification module translates the analysis results, the following modules will process the results of the odd number processing module according to user's feedback.

Further, the odd-even classification module utilizes a unique classification algorithm to categorize all Chinese vocabulary into odd and even classes; this classification process is based on a deep understanding of the intrinsic properties of vocabulary, ensuring accuracy and reliability in the classification; through this module, the system can transmit the vocabulary to the corresponding subsequent processing modules based on their properties, thereby performing targeted processing.

Further, the odd number processing module is used to apply a specific Pinyin reorganizing method to odd class vocabulary to obtain the corresponding oracle bone inscription; the odd number processing module finely decomposes the reverse Pinyin letters with the median as the superposition, and then further splits and reorganizes them, comprising multi-directional dislocation reorganization, cross reorganization, or the reverse positive stacking reorganization, opposition reorganization with the median as the superposition, and then the corresponding oracle bone inscription can be obtained.

Further, the even number processing module processes by decomposing and reorganizing the opposite Pinyin letters in vertical columns, or decomposing and reorganizing the parallel Pinyin letters in horizontal columns; these techniques can fully explore the characteristics of even-numbered vocabulary, ensuring the accuracy and completeness of digital images.

Further, the database module is responsible for storing all Chinese vocabulary and their corresponding oracle bone inscription image data, ensuring the integrity and consistency of the data; through supporting real-time query and update functions, the database module improves the efficiency and accuracy of the system, making it convenient for users to query, update and use relevant data.

Further, the graphical display module supports multiple output formats, allowing users to flexibly view and edit oracle bone inscription images; this diversified display method meets the needs of different users and provides a richer and more intuitive visual experience; users can choose different formats for viewing and editing based on their own needs, making the display of oracle bone inscription images more diverse.

Further, the system comprises any language system composed of 0s and 1s, which can be restructured in the aforementioned manner to obtain complete and intact oracle bone inscription images; it supports the processing and display of super-complex phenomena and quantum-scale graphical phenomena.

Compared with existing technologies, the advantages of the invention are as follows: comprehensive restoration capabilities for oracle bone inscriptions: by combining the odd-even classification module, the odd number processing module and the even number processing module, this system is capable of comprehensive restoration of oracle bone inscriptions for different types of Chinese vocabulary; this classification processing improves the accuracy and efficiency of restoration.

Innovative Pinyin reorganizing technology: finely decomposing the reverse Pinyin letters with the median as the superposition, and then further splitting and reorganizing them (comprising multi-directional dislocation reorganization, cross reorganization), or the reverse positive stacking reorganization, opposition reorganization with the median as the superposition, which provides a unique oracle bone inscription recovery method for the odd-numbered words. For the even-numbered words, decomposing and reorganizing the opposite Pinyin letters in vertical columns, or decomposing and reorganizing the parallel Pinyin letters in horizontal columns, which further enriches the restoration methods.

Powerful database support: through the database module, this system is capable of storing and managing a large amount of Chinese vocabulary and their corresponding oracle bone inscription image data; this not only supports real-time queries and updates, but also provides rich data resources for subsequent research and applications.

Diversified graphical display function: the graphical display module can present oracle bone inscription images obtained through various methods and support multiple output formats, meeting the needs of different users and enhancing the system's practicality and flexibility.

Compatibility and scalability: this system can handle any language system composed of 0s and 1s, showcasing its potential in processing complex and large-scale data; moreover, it also supports the processing and presentation of super-complex phenomena and quantum-scale graphical phenomena, demonstrating its enormous potential in future technological development.

Promoting ancient character researches and cultural heritage: by efficiently and accurately restoring and presenting oracle bone inscription images, this system contributes to promoting the development of ancient character researches and promoting the inheritance and protection of cultural heritage.

In summary, the digital graphical language system for oracle bone inscriptions, through its unique design and functions, provides strong technical support for the research, protection, and inheritance of oracle bone inscriptions, and has extensive application prospects and profound social significance.

### 4. BRIEF DESCRIPTION OF ACCOMPANY DRAWINGS

FIG. 1 is a schematic diagram of the overall module of a digital graphical language system for oracle bone inscriptions of the invention.

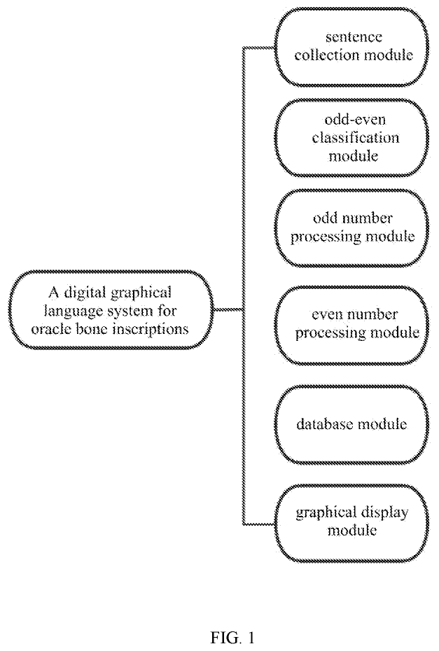

### 5. SPECIFIC EMBODIMENT OF THE INVENTION

In order to make the object, technical schemes and advantages of the embodiments of the invention clearer, the following will be combined with the accompanying drawings of the embodiments of the invention. Obviously, the described embodiments are part of the embodiments of the invention, rather than all the embodiments.

### Embodiment 1

A digital graphical language system for oracle bone inscriptions comprises a sentence collection module 1, an odd-even classification module 2, an odd number processing module 3, an even number processing module 4, a database module 5, and a graphical display module 6; the system first transmits the collected information to the odd-even classification module 2 through the sentence collection module 1 for classification; then, the information is separately sent to the odd number processing module 3 or even number processing module 4 for reorganizing of Pinyin letters; finally, the corresponding oracle bone inscription image is obtained and displayed through the graphical display module 6.

The sentence collection module 1 is used to collect Chinese articles and sentences, and transmit the collected information to the odd-even classification module 2; the odd-even classification module 2 analyzes the articles and sentences collected by the sentence collection module 1, and translates the analyzed results into other languages for output; after the odd-even classification module 2 translates the analysis results, the following modules will process the results of the odd number processing module 3 according to user's feedback.

The odd-even classification module 2 utilizes a unique classification algorithm to categorize all Chinese vocabulary into odd and even classes; this classification process is based on a deep understanding of the intrinsic properties of vocabulary, ensuring accuracy and reliability in the classification; through this module, the system can transmit the vocabulary to the corresponding subsequent processing modules based on their properties, thereby performing targeted processing.

The odd number processing module 3 is used to apply a specific Pinyin reorganizing method to odd class vocabulary to obtain the corresponding oracle bone inscription; the odd number processing module finely decomposes the reverse Pinyin letters with the median as the superposition, and then further splits and reorganizes them, comprising multi-directional dislocation reorganization, cross reorganization, or the reverse positive stacking reorganization, opposition reorganization with the median as the superposition, and then the corresponding oracle bone inscription can be obtained.

The even number processing module 4 processes by decomposing and reorganizing the opposite Pinyin letters in vertical columns, or decomposing and reorganizing the parallel Pinyin letters in horizontal columns; these techniques can fully explore the characteristics of even-numbered vocabulary, ensuring the accuracy and completeness of digital images.

The database module 5 is responsible for storing all Chinese vocabulary and their corresponding oracle bone inscription image data, ensuring the integrity and consistency of the data; through supporting real-time query and update functions, the database module improves the efficiency and accuracy of the system, making it convenient for users to query, update and use relevant data.

The graphical display module 6 supports multiple output formats, allowing users to flexibly view and edit oracle bone inscription images; this diversified display method meets the needs of different users and provides a richer and more intuitive visual experience; users can choose different formats for viewing and editing based on their own needs, making the display of oracle bone inscription images more diverse.

The system comprises any language system composed of 0s and 1s, which can be restructured in the aforementioned manner to obtain complete and intact oracle bone inscription images; it supports the processing and display of super-complex phenomena and quantum-scale graphical phenomena.

### Embodiment 2

The Chinese articles and sentences are collected from various documents and materials through the sentence collection module 1. This module uses advanced natural language processing technology to accurately and efficiently collect articles and sentences. After preliminary processing, the collected information is transmitted to the odd-even classification module 2.

The odd-even classification module 2 uses a unique classification algorithm to analyze the articles and sentences collected by the sentence collection module 1. This algorithm is based on an in-depth understanding of the intrinsic properties of vocabulary and is able to classify all Chinese words into odd and even classes. The classified results will be transmitted to the subsequent odd number processing module 3 or even number processing module 4 for further processing.

For the odd class vocabulary, the odd number processing module 3 is used to apply a specific Pinyin reorganizing method to process. Specifically, the module finely decomposes the reverse Pinyin letters with the median as the superposition, and then further splits and reorganizes them. These technologies comprise multi-directional dislocation reorganization, cross reorganization, or the reverse positive stacking reorganization, opposition reorganization with the median as the superposition. Through these technologies, the odd number processing module 3 can obtain the corresponding oracle bone inscription images.

For the even class vocabulary, the even number processing module 4 processes by decomposing and reorganizing the opposite Pinyin letters in vertical columns, or decomposing and reorganizing the parallel Pinyin letters in horizontal columns. These techniques can fully explore the characteristics of even-numbered vocabulary, ensuring the accuracy and completeness of digital images.

After the processing is completed, the database module 5 stores all Chinese vocabulary and their corresponding oracle bone inscription image data. The database module 5 can ensure the integrity and consistency of the data, supporting real-time query and update functions. Users can easily query, update and use relevant data according to their own needs.

Finally, the graphical display module 6 is responsible for displaying the final oracle bone inscription images, this module supports multiple output formats, allowing users to flexibly view and edit oracle bone inscription images. This diversified display method meets the needs of different users and provides a richer and more intuitive visual experience. Users can choose different formats for viewing and editing based on their own needs, making the display of oracle bone inscription images more diverse.

In addition, the system comprises any language system composed of 0s and 1s. This means that the system can not only process Chinese oracle bone inscriptions, but can also be used for the research and analysis of other languages. In this way, the system supports the processing and display of super-complex phenomena and quantum-scale graphical phenomena, providing strong technical support and guarantee for multi-field cultural research.

In summary, the embodiments provide a specific implementation scheme for a digital graphical language system for oracle bone inscriptions. By integrating multiple modules and technical schemes, the system achieves comprehensive digital processing and display of oracle bone inscriptions. Its innovative classification algorithm and technical schemes improve the efficiency and accuracy of research, and provide users with more flexible and diverse application scenarios. It classifies all the word groups and vocabulary of the Chinese database into odd and even classes. For the odd-numbered class: (1) by finely decomposing the reverse Pinyin letters with the median as the superposition, and then further splitting and reorganizing them (multi-directional dislocation reorganization, cross reorganization), or the reverse positive stacking reorganization, opposition reorganization with the median as the superposition, and then the corresponding oracle bone inscription can be obtained; for the even-numbered class: (1) decomposing and reorganizing the opposite Pinyin letters in vertical columns, (2) decomposing and reorganizing the parallel Pinyin letters in horizontal columns, and then the corresponding oracle bone inscription can be obtained. By analogy, all oracle bone inscriptions restoration of all Chinese phrases and vocabulary can be completed, and a digital oracle bone inscription recovery system can be created in turn.

Simplified application of technology: any language system composed of 0s and 1s can be restructured in the aforementioned manner to obtain complete and intact oracle bone inscription images, and supports the super-complex phenomena and quantum-scale graphical phenomena.

The invention and its embodiments have been described above, this description is not restrictive, and what is shown in the accompanying drawing is only one of the embodiments of the invention, and the actual structure is not limited to this. All in all, if those skilled in the art receives its enlightenment, without deviating from the object of the invention, and without creatively designing structures and embodiments similar to the technical scheme of the invention shall fall within the protection scope of the invention.

1. A digital graphical language system for oracle bone inscriptions comprises a sentence collection module (1), an odd-even classification module (2), an odd number processing module (3), an even number processing module (4), a database module (5), and a graphical display module (6); the system first transmits the collected information to the odd-even classification module (2) through the sentence collection module (1) for classification; then, the information is separately sent to the odd number processing module (3) or even number processing module (4) for reorganizing of Pinyin letters; finally, the corresponding oracle bone inscription image is obtained and displayed through the graphical display module (6).

2. A digital graphical language system for oracle bone inscriptions of claim 1, the sentence collection module (1) is used to collect Chinese articles and sentences, and transmit the collected information to the odd-even classification module (2); the odd-even classification module (2) analyzes the articles and sentences collected by the sentence collection module (1), and translates the analyzed results into other languages for output; after the odd-even classification module (2) translates the analysis results, the following modules will process the results of the odd number processing module (3) according to user's feedback.

3. A digital graphical language system for oracle bone inscriptions of claim 1, the odd-even classification module (2) utilizes a unique classification algorithm to categorize all Chinese vocabulary into odd and even classes; this classification process is based on a deep understanding of the intrinsic properties of vocabulary, ensuring accuracy and reliability in the classification; through this module, the system can transmit the vocabulary to the corresponding subsequent processing modules based on their properties, thereby performing targeted processing.

4. A digital graphical language system for oracle bone inscriptions of claim 1, the odd number processing module (3) is used to apply a specific Pinyin reorganizing method to odd class vocabulary to obtain the corresponding oracle bone inscription; the odd number processing module finely decomposes the reverse Pinyin letters with the median as the superposition, and then further splits and reorganizes them, comprising multi-directional dislocation reorganization, cross reorganization, or the reverse positive stacking reorganization, opposition reorganization with the median as the superposition, and then the corresponding oracle bone inscription can be obtained.

5. A digital graphical language system for oracle bone inscriptions of claim 1, the even number processing module (4) processes by decomposing and reorganizing the opposite Pinyin letters in vertical columns, or decomposing and reorganizing the parallel Pinyin letters in horizontal columns; these techniques can fully explore the characteristics of even-numbered vocabulary, ensuring the accuracy and completeness of digital images.

6. A digital graphical language system for oracle bone inscriptions of claim 1, the database module (5) is responsible for storing all Chinese vocabulary and their corresponding oracle bone inscription image data, ensuring the integrity and consistency of the data; through supporting real-time query and update functions, the database module improves the efficiency and accuracy of the system, making it convenient for users to query, update and use relevant data.

7. A digital graphical language system for oracle bone inscriptions of claim 1, the graphical display module (6) supports multiple output formats, allowing users to flexibly view and edit oracle bone inscription images; this diversified display method meets the needs of different users and provides a richer and more intuitive visual experience; users can choose different formats for viewing and editing based on their own needs, making the display of oracle bone inscription images more diverse.

8. A digital graphical language system for oracle bone inscriptions of claim 1, the system comprises any language system composed of 0s and 1s, which can be restructured in the aforementioned manner to obtain complete and intact oracle bone inscription images; it supports the processing and display of super-complex phenomena and quantum-scale graphical phenomena.
